(19) United States
(12) Patent Application Publication
(10) Pub. No.: US 2021/0033359 A1
(43) Pub. Date: Feb. 4, 2021

(54) ALUMINUM ALLOY HEAT EXCHANGER FOR EXHAUST GAS RECIRCULATION SYSTEM

(71) Applicants: UACJ Corporation, Tokyo (JP); DENSO CORPORATION, Kariya-shi, Aichi (JP)

(72) Inventors: Yoshiyuki Oya, Tokyo (JP); Tomohiro Shoji, Tokyo (JP); Atsushi Fukumoto, Tokyo (JP); Kouki Nishiyama, Kariya-shi (JP); Toru Ikeda, Kariya-shi (JP); Takahiro Shinoda, Kariya-shi (JP)

(73) Assignees: UACJ Corporation, Tokyo (JP); DENSO CORPORATION, Kariya-shi, Aichi (JP)

(21) Appl. No.: 17/043,064

(22) PCT Filed: Mar. 27, 2019
(86) PCT No.: PCT/JP2019/013301

§ 371 Date: Sep. 29, 2020

(30) Foreign Application Priority Data
Mar. 29, 2018 (JP) 2018-063776

(51) Int. Cl. F28F 21/08; F01N 5/02; F28D 21/00; F28F 19/06

(52) U.S. Cl. CPC F28F 21/084; F01N 5/02; F28F 2275/04; F28F 21/089; F28F 19/06; F28D 21/0003

(57) ABSTRACT

An aluminum alloy heat exchanger for an exhaust gas recirculation system, which is a heat exchanger installed in an exhaust gas recirculation system of an internal combustion engine to cool the exhaust gas comprises a tube provided with a sacrificial anticorrosion material on a side along which the exhaust gas passes, and a fin brazed to the surface side of the sacrificial anticorrosion material of the tube, the fin having a pitting potential higher than the pitting potential of the surface of the sacrificial anticorrosion material of the tube. According to the disclosure, an aluminum alloy heat exchanger for an exhaust gas recirculation system having a long service life with effective function of the sacrificial anticorrosion even under an acidic environment in which an oxide film is weakened as a whole and pitting corrosion is unlikely to occur can be provided.

### TECHNICAL FIELD

The present invention relates to, in an exhaust gas recirculation system for recirculating the exhaust gas of an internal combustion engine mounted on a vehicle, an aluminum alloy heat exchanger for the exhaust gas recirculation system to cool the exhaust gas by heat exchange.

### BACKGROUND ART

An aluminum (Al) alloy is lightweight and has excellent thermal conductivity, capable of achieving high corrosion resistance by an appropriate processing and efficient joining by brazing using a brazing sheet, having been widely used as material for a heat exchanger.

In recent years, improvement in performance of a heat exchanger having high durability with a lighter weight has been required to achieve improvement in performance of automobiles or environmental friendliness, so that development is urged to make an aluminum alloy material that can meet the requirement.

For example, in a heat exchanger such as a condenser and an evaporator of an automotive air conditioner, weight saving by further reducing thickness of a tube and an external fin has been performed, and a chromate conversion treatment having high anticorrosion effect tends to be excluded by environmental regulations. Further, factors for accelerating corrosion such as use of a large amount of a snow melting agent, atmospheric pollution and acid rain have increased.

As one form of the heat exchanger for automobiles, a combination of a tube formed from a three-layer brazing sheet in a clad structure including a brazing material, a core material and a sacrificial anticorrosion layer, and an external fin formed by corrugating a single-layer external fin material, with the tube and the fin joined by brazing, is currently used.

Since the tube is used for circulating a fluid such as refrigerant, the occurrence of leak caused by pitting is a fatal wound for a heat, exchanger.

Accordingly, examples of the effective anticorrosion method for suppressing the occurrence of pitting of the tube include a widely used anticorrosion method for a core material, in which an Al—Zn layer is formed on the surface of the tube by clad rolling or the like so as to achieve a sacrificial anticorrosion effect of the Al—Zn layer (e.g., Patent Literature 1 and Patent Literature 2). Further, in order to impart some sacrificial effect to the external fin, addition of Zn or like to the external fin material is performed to ensure the corrosion resistance of the tube.

### CITATION LIST

### Patent Literature

[Patent Literature 1] Japanese Patent Laid-Open No. 2014-177694
[Patent Literature 2] Japanese Patent Laid-Open No. 2014-178101

### SUMMARY OF INVENTION

### Technical Problem

In a heat exchanger for the exhaust gas recirculation system to cool the exhaust gas of an internal combustion engine mounted on a vehicle by heat exchange, however, the condensed water thereof becomes acidic, so that aluminum is corroded. Under an acidic environment, an oxide film is weakened as a whole and pitting is unlikely to occur, which causes the following problem: sacrificial anticorrosion, which provides anticorrosion using pitting potential difference, is unlikely to function.

Accordingly, an object of the present invention is to provide an aluminum alloy heat exchanger for an exhaust gas recirculation system having a long service life with effective function of sacrificial anticorrosion, even under an acidic environment in which an oxide film is weakened as a whole and pitting is unlikely to occur.

### Solution to Problem

The problem can be solved by the present invention described below.

That is, the present invention (1) provides an aluminum alloy heat exchanger for an exhaust gas recirculation system, which is a heat exchanger installed in an exhaust gas recirculation system of an internal combustion engine to cool the exhaust gas, comprising:

a tube provided with a sacrificial anticorrosion material on a side along which the exhaust gas passes, and a fin brazed to a sacrificial anticorrosion material surface side of the tube,

the fin having a pitting potential higher than a pitting potential of a sacrificial anticorrosion material surface of the tube.

Also, the present invention (2) provides the aluminum alloy heat exchanger for an exhaust gas recirculation system according to (1), wherein the condensed water of the exhaust gas has a pH of less than 3 and a chloride ion concentration of less than 100 ppm.

Also, the present invention (3) provides the aluminum alloy heat exchanger for an exhaust gas recirculation system according to (1) or (2), wherein the heat exchanger is obtained by brazing: a tube material comprising at least a core material made of aluminum alloy comprising 0.05 mass % or more and 1.50 mass % or less of Si, 0.05 mass % or more and 3.00 mass % or less of Cu, and 0.40 mass % or more and 2.00 mass % or less of Mn, with the balance being Al and unavoidable impurities, and a sacrificial anticorrosion material made of aluminum alloy comprising 3.00 mass % or more and 13.00 mass % or less of Si and 0.50 mass % or more and 6.00 mass % or less of Zn, with the balance being Al and unavoidable impurities, clad on an exhaust gas passage side surface of the core material; and a fin material comprising a core material made of aluminum alloy comprising 0.05 mass % or more and 1.50 mass % or less of Si, 0.40 mass % or more and 2.00 mass % or less of Mn, and 0 mass % or more and 0.05 mass % or less of Zn, with the balance being Al and unavoidable impurities.

Also, the present invention (4) provides the aluminum alloy heat exchanger for an exhaust gas recirculation system of claim 3, wherein the core material of the fin material further comprises one or more selected from the group consisting of 0.05 mass % or more and 0.50 mass % or less of Mg and 0.10 mass % or more and 1.00 mass % or less of Fe.

Also, the present invention (5) provides the aluminum alloy heat exchanger for an exhaust gas recirculation system according to (1) or (2), wherein the heat exchanger is obtained by brazing: a tube material comprising at least a core material made of aluminum alloy comprising 0.05 mass % or more and 1.50 mass % or less of Si, 0.05 mass % or more and 3.00 mass % or less of Cu, and 0.40 mass % or more and 2.00 mass % or less of Mn, with the balance being Al and unavoidable impurities, and a sacrificial anticorrosion material made of aluminum alley comprising 3.00 mass % or more and 13.00 mass % or less of Si, and 0.50 mass % or more and 6.00 mass % or less of Zn, with the balance being Al and unavoidable impurities, clad on an exhaust gas passage side surface of the core material; and a fin material comprising a core material made of aluminum alloy comprising 0.05 mass % or more and 1.50 mass % or less of Si, 0.40 mass % or more and 2.00 mass % or less of Mn, and 0.00 mass % or more and 0.05 mass % or less of Zn, with the balance being Al and unavoidable impurities, and a first brazing material clad on one surface of the core material and a second brazing material clad on another surface of the core material, made of aluminum alloy comprising 3.00 mass % or more and 13.00 mass % or less of Si and 0.00 mass % or more and 0.05 mass % or less of Zn, with the balance being Al and unavoidable impurities.

Also, the present invention (6) provides the aluminum alloy heat exchanger for an exhaust gas recirculation system according to (5), wherein the core material of the fin material further comprises one or more selected from the group consisting of 0.05 mass % or more and 0.50 mass % or less of Mg and 0.10 mass % or more and 1.00 mass % or less of Fe.

Also, the present invention (7) provides the aluminum alloy heat exchanger for an exhaust gas recirculation system according to any one of (3) to (6), wherein the tube material comprises a brazing material comprising 3.00 mass % or more and 13.00 mass % or less of Si and 0.00 mass % or more and 0.05 mass % or less of Zn, with the balance being Al and unavoidable impurities, clad on a surface opposite to the surface clad with a sacrificial anticorrosion material of the tube material.

Also, the present invention (8) provides the aluminum alloy heat exchanger for an exhaust gas recirculation system according to any one of (3) to (7), wherein the core material of the tube material further comprises one or more selected from the group consisting of 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V.

Also, the present invention (9) provides the aluminum alloy heat exchanger for an exhaust gas recirculation system of any one of claims 3 to 8, wherein the sacrificial anticorrosion material of the tube material further comprises one or more selected from the group consisting of 0.05 mass % or more and 2.00 mass % or less of Mn, 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of In, 0.05 mass % or more and 0.30 mass % or less of Sn, 0.05 mass % or more and 0.30 mass % or less of Ti, 0.05 mass % or more and 0.30 mass % or less of V, 0.05 mass % or more and 0.30 mass % or less of Cr, and 0.05 mass % or more and 0.30 mass % or less of Zr.

### Advantageous Effect of Invention

According to the present invention, an aluminum alloy heat exchanger for an exhaust gas recirculation system comprising a fin joined by brazing in a path through which an exhaust gas circulates, which has a long service life with effective function of the sacrificial anticorrosion even under an acidic environment in which an oxide film is weakened as a whole and pitting is unlikely to occur, can be provided.

### Description of Embodiment

The aluminum alloy heat exchanger for an exhaust gas recirculation system according to the present invention is a heat exchanger installed in an exhaust gas recirculation system of an internal combustion engine to cool the exhaust gas, comprising
a tube provided with a sacrificial anticorrosion material on a side along which the exhaust gas passes, and a fin brazed to a sacrificial anticorrosion material surface of the tube,
the fin having a pitting potential higher than a pitting potential of a sacrificial anticorrosion material surface of the tube.

The aluminum alloy heat exchanger for an exhaust gas recirculation system according to the present invention is a heat exchanger installed in an exhaust gas recirculation system of an internal combustion engine mounted on a vehicle to cool the exhaust gas of the internal combustion engine by heat exchange. The aluminum alloy heat exchanger for an exhaust gas recirculation system according to the present, invention comprises a tube made of aluminum alloy, provided with a sacrificial anticorrosion material on a side along which the exhaust gas passes, and a fin made of aluminum alloy, brazed to the surface of the sacrificial anticorrosion material of the tube.

The aluminum alloy heat exchanger for an exhaust gas recirculation system according to the present invention is manufactured by the steps of forming a tube material made of aluminum alloy and having a sacrificial anticorrosion material such that the sacrificial anticorrosion material is on a side that comes into contact with an exhaust gas, forming a fin material made of aluminum alloy into a fin shape, and then disposing the formed fin material on the sacrificial anticorrosion material surface of the formed tube material so as to be brazed by brazing heating.

In the heat exchanger for an exhaust gas recirculation system of an internal combustion engine, an acidic condensed water is produced by cooling of the exhaust gas of the internal combustion engine, so that an oxide film is weakened as a whole and pitting is unlikely to occur. As a result, sacrificial anticorrosion, which provides anticorrosion using pitting potential difference, is unlikely to function. Also, since pitting is a phenomenon induced by chloride ions, sacrificial anticorrosion is further unlikely to work under an environment with a low chloride ion concentration.

Accordingly, in the aluminum alloy heat exchanger for an exhaust gas recirculation system according to the present invention, the pitting potential of the fin is raised higher than the pitting potential of the sacrificial anticorrosion material surface of the tube to achieve effective sacrificial anticorrosion. In other words, in the aluminum alloy heat exchanger for an exhaust gas recirculation system according to the present invention, the pitting potential of the fin is higher than the pitting potential of the sacrificial anticorrosion material surface of the tube, so that pitting occurs on the surface of the tube, resulting in effective sacrificial anticorrosion. In the aluminum alloy heat exchanger for an exhaust gas recirculation system according to the present invention, the pitting potential of the fin is higher than the pitting potential of the sacrificial anticorrosion material surface of the tube preferably by 20 mV or more, particularly preferably by 50 mV or more. The pitting potential of the core material of the fin refers to the pitting potential of the core material constituting the fin material when the fin is made of brazed bare fin material comprising core material only, and refers to the pitting potential of the core material of the fin material when the fin is made of brazed fin material of a clad material including a core material and a brazing material.

The aluminum alloy heat exchanger for an exhaust gas recirculation system in a first embodiment according to the present invention is an aluminum alloy heat exchanger which is obtained by brazing a tube material (A) and a fin material (A). Also, the aluminum alloy heat exchanger for an exhaust gas recirculation system in a second embodiment according to the present invention is an aluminum alloy heat exchanger which is obtained by brazing a tube material (A) and a fin material (B).

The tube material (A) comprises at least a core material made of aluminum alloy comprising 0.05 mass % or more and 1.50 mass % or less of Si, 0.05 mass % or more and 3.00 mass % or less of Cu, and 0.40 mass % or more and 2.00 mass % or less of Mn, with the balance being Al and unavoidable impurities, and a sacrificial anticorrosion material made of aluminum alloy comprising 3.00 mass % or more and 13.00 mass % or less of Si and 0.50 mass % or more and 6.00 mass % or less of Zn, with the balance being Al and unavoidable impurities, clad on an exhaust, gas passage side surface of the core material. In other words, the tube material (A) is a clad material including at least a sacrificial anticorrosion material clad on a core material.

The core material of the tube material (A) is aluminum alloy comprising 0.05 mass or more and 1.50 mass % or less of Si, 0.05 mass % or more and 3.00 mass % or less of Cu, and 0.40 mass % or more and 2.00 mass % or less of Mn, with the balance being Al and unavoidable impurities.

The Si content in the core material of the tube material (A) is 0.05 mass % or more and 1.50 mass % or less, preferably 0.40 mass % or more and 0.80 mass % or less. With a Si content in the core material of the tube material (A) in the range, Si is solid-dissolved in a matrix or forms an Al-Mn-Si-based intermetallic compound, so that the strength of the tube after brazing is enhanced. Further, with the addition of Si, the potential of the core material becomes noble to increase the potential difference between the core material and the sacrificial anticorrosion material, so that the corrosion resistance of the tube is enhanced. In contrast, with a Si content in the core material of the tube material below the range, the effect of the addition of Si cannot be obtained, while with a Si content exceeding the range, the corrosion resistance of the tube may decrease due to singly crystallized Si, and the lowered melting point of the alloy results in melting of the tube material during brazing.

The Cu content in the core material of the tube material (A) is 0.05 mass % or more and 3.00 mass % or less, preferably 0.30 mass % or more and 0.80 mass % or less. With a Cu content in the core material of the tube material (A) in the range, the potential of aluminum becomes noble, so that the sacrificial anticorrosion effect of the sacrificial anticorrosion material is enhanced. With a Cu content in the core material of the tube material below the range, the effect of the addition of Cu cannot be obtained, while with a Cu content exceeding the range, a Cu-based intermetallic compound precipitates in the aluminum alloy resulting from thermal history in manufacturing of the material and brazing heating so as to accelerate the cathode reaction, so that the corrosion rate of the sacrificial anticorrosion material increases.

The Mn content in the core material of the tube material (A) is 0.40 mass % or more and 2.00 mass % or less, preferably 0.80 mass % or more and 1.60 mass % or less. With a Mn content of the core material of the tube material (A) in the range, Mn crystallises or precipitates as an Al-Mn-based intermetallic compound to enhance the strength of the tube after brazing heating. Further, the Al-Mn-based intermetallic compound incorporates Fe, so that the inhibitory effect on corrosion resistance by Fe as an unavoidable impurity can be suppressed. In contrast, with a Mn content in the core material of the tube material below the range, the effect of the addition of Mn cannot be obtained, while with a Mn content exceeding the range, a giant intermetallic compound may crystallize to inhibit the manufacturability of the tube.

The core material of the tube material (A) may further comprise one or more selected from the group consisting of 0.05 mass % or more and 0.50 mass % or less of Mg, 0.10 mass % or more and 1.00 mass % or less of Fe, 0.05 mass % or more and 1.00 mass % or less or Ni, 0.05 mass % or more and 0.30 mass % or less of Cr, 0.05 mass % or more and 0.30 mass % or less of Zr, and 0.05 mass % or more and 0.30 mass % or less of Ti, and 0.05 mass % or more and 0.30 mass % or less of V, on an as needed basis.

When the core material of the tube material (A) comprises Mg, the Mg content in the core material of the tube material (A) is 0.05 mass % or more and 0.50 mass % or less, preferably 0.10 mass % or more and 0.30 mass % or less. With a Mg content in the core material of the tube material (A) in the range, the corrosion resistance, particularly the resistance to pitting of the tube is enhanced. In contrast, with a Mg content in the core material of the tube material below the range, the effect of the addition of Mg cannot be obtained, while with a Mg content exceeding the range, brazing may be inhibited in some cases.

When the core material of the tube material (A) comprises Fe, the Fe content in the core material of the tube material (A) is 0.10 mass % or more and 1.00 mass % or less. With a Fe content in the core material of the tube material (A) in the range, the corrosion is dispersed to improve the penetration life. In contrast, with a Fe content in the core material of the tube material below the range, the effect of the addition of Fe cannot be obtained, while with a Fe content exceeding the range, the corrosion rate of the tube remarkably increases.

When the core material of the tube material (A) comprises Ni, the Ni content in the core material of the tube material (A) is 0.05 mass % or more and 1.00 mass % or less. With a Ni content in the core material of the tube material (A) in the range, the corrosion is dispersed to improve the penetration life. In contrast, with a Ni content in the core material of the tube material below the range, the effect of the addition of Ni cannot be obtained, while with a Ni content exceeding the range, the corrosion rate of the tube remarkably increases.

When the core material of the tube material (A) comprises Ti, the Ti content in the core material of the tube material (A) is 0.05 mass % or more and 0.30 mass % or less, preferably 0.10 mass % or more and 0.20 mass % or less. When the core material of the tube material (A) comprises Zr, the Zr content in the core material of the tube material (A) is 0.05 mass % or more and 0.30 mass % or less, preferably 0.10 mass % or more and 0.20 mass % or less. When the core material of the tube material (A) comprises Cr, the Cr content in the core material of the tube material (A) is 0.05 mass % or more and 0.30 mass % or less, preferably 0.10 mass % or more and 0.20 mass % or less. When the core material of the tube material (A) comprises V, the V content in the core material of the tube material (A) is 0.05 mass % or more and 0.30 mass % or less, preferably 0.10 mass % or more and 0.20 mass % or less. Ti, Zr, Cr and V in the core material of the tube material contribute the improvement of the corrosion resistance, particularly the resistance to pitting. Regions with a high content of Ti, Zr, Cr and V added to the aluminum alloy and regions with a low content thereof are separated and alternately distributed in a laminated form along the plate thickness direction of the material. The regions with a low content are preferentially corroded in comparison with the regions with a high content, so that a layered corrosion state is obtained. As a result, a difference in the rate of corrosion along the plate thickness direction of the material partially occurs, so that the progress of the corrosion is suppressed as a whole to improve the resistance to pitting. With a Ti, Zr, Cr or V content in the core material of the tube material below the range, the effect of the addition of Ti, Zr, Cr or V cannot be obtained, while with a content exceeding the range, a coarse compound may be formed in casting so as to inhibit the manufacturability of the tube in some cases.

The sacrificial anticorrosion material of the tube material (A) is made of aluminum alloy comprising 3.00 mass % or more and 13.00 mass % or less of Si and 0.50 mass % or more and 6.00 mass % or less of Zn, with the balance being Al and unavoidable impurities, clad on an exhaust gas passage side surface of the core material, that is, a side along which the exhaust gas flows.

The Si content in the sacrificial anticorrosion material of the tube material (A) is 3.00 mass % or more and 13.00 mass % or less. With a Si content in the sacrificial anticorrosion material of the tube material (A) in the range, Si lowers the melting point of aluminum, so that the function as brazing material can be imparted to the sacrificial anticorrosion material. In contrast, with a Si content in the sacrificial anticorrosion material of the tube material (A) below the range, the effect of the addition of Si cannot be obtained, while with a Si content exceeding the range, a giant intermetallie compound may crystallize to inhibit the manufacturability of the tube.

The Zn content in the sacrificial anticorrosion material of the tube material (A) is 0.05 mass % or more and 6.00 mass % or less, preferably 1.00 mass % or more and 3.00 mass % or less. With a Zn content in the sacrificial anticorrosion material of the tube material (A) in the range, the pitting potential decreases to enhance the function as the sacrificial anticorrosion material. In contrast, with a Zn content in the sacrificial anticorrosion material of the tube material (A) below the range, the effect of the addition of Zn cannot be obtained, while with a Zn content exceeding the range, cracking may occur in casting.

The sacrificial anticorrosion material of the tube material (A) may further comprise one or more selected from the group consisting of 0.05 mass % or more and 2.00 mass % or less of Mn, 0.05 mass % or more and 0.50 mass % or less of Mg, 0.10 mass % or more and 1.00 mass % or less of Fe, 0.05 mass % or more and 1.00 mass % or less of Mi, 0.05 mass % or more and 0.30 mass % or less of In, 0.05 mass % or more and 0.30 mass % or less of Sn, 0.05 mass % or more and 0.30 mass % or less of Ti, 0.05 mass % or more and 0.30 mass % or less of V, 0.05 mass % or more and 0.30 mass % or less of Cr, and 0.05 mass % or more and 0.30 mass % or less of Zr, on an as needed basis.

When the sacrificial anticorrosion material of the tube material (A) comprises Mn, the Mn content in the sacrificial anticorrosion material of the tube material (A) is 0.05 mass % or more and 2.00 mass % or less, preferably 0.20 mass % or more and 1.00 mass % or less. With a Mn content in the sacrificial anticorrosion material of the tube material (A) in the range, Mn forms an Al-Mn-based intermetallie compound to incorporate Fe, so the inhibitory effect on corrosion resistance by Fe as an unavoidable impurity can be suppressed. In contrast, with a Mn content in the sacrificial anticorrosion material of the tube material below the range, the effect of the addition of Mn cannot be obtained, while with a Mn content exceeding the range, a giant intermetallic compound may crystallize to inhibit the manufacturability of the tube.

When the sacrificial anticorrosion material of the tube material (A) comprises Mg, the Mg content in the sacrificial anticorrosion material of the tube material (A) is 0.05 mass % or more and 0.50 mass % or less, preferably 0.10 mass % or more and 0.30 mass % or less. With a Mg content in the sacrificial anticorrosion material of the tube material (A) in the range, the corrosion resistance, particularly the resistance to pitting is enhanced. In contrast, with a Mg content in the sacrificial anticorrosion material of the tube material below the range, the effect of the addition of Mg cannot be obtained, while with a Mg content exceeding the range, brazing may be inhibited in some cases.

When the sacrificial anticorrosion material of the tube material (A) comprises Fe, the Fe content in the sacrificial anticorrosion material of the tube material (A) is 0.10 mass % or more and 1.00 mass % or less. With a Fe content in the sacrificial anticorrosion material of the tube material (A) in the range, the corrosion is dispersed to improve the penetration life. In contrast, with a Fe content below the range, the effect of the addition of Fe cannot be obtained, while with a Fe content exceeding the range, the corrosion rate of the tube remarkably increases.

When the sacrificial anticorrosion material of the tube material (A) comprises Ni, the Ni content in the sacrificial anticorrosion material of the tube material (A) is 0.05 mass % or more and 1.00 mass % or less. With a Ni content, in the sacrificial anticorrosion material of the tube material (A) in the range, the corrosion is dispersed to improve the penetration life. In contrast, with a Ni content below the range, the effect of the addition of Ni cannot be obtained, while with a Ni content exceeding the range, the corrosion rate of the tube remarkably increases.

When the sacrificial anticorrosion material of the tube material (A) comprises In, the In content in the sacrificial anticorrosion material of the tube material (A) is 0.05 mass % or more and 0.30 mass % or less. With an In content in the sacrificial anticorrosion material of the tube material (A) in the range, the pitting potential decreases to enhance the function as the sacrificial anticorrosion material. In contrast, with an In content in the sacrificial anticorrosion material of the tube material below the range, the effect of the addition of In cannot be obtained, while with an In content exceeding the range, the corrosion rate of the sacrificial anticorrosion material remarkably increases.

When the sacrificial anticorrosion material of the tube material (A) comprises Sn, the Sn content in the sacrificial anticorrosion material of the tube material (A) is 0.05 mass % or more and 0.30 mass % or less. With a Sn content in the sacrificial anticorrosion material of the tube material (A) in the range, the pitting potential decreases to enhance the function as the sacrificial anticorrosion material. In contrast, with a Sn content in the sacrificial anticorrosion material of the tube material below the range, the effect of the addition of Sn cannot, be obtained, while with a Sn content exceeding the range, the corrosion rate of the sacrificial anticorrosion material remarkably increases.

When the sacrificial anticorrosion material of the tube material (A) comprises Ti, the Ti content in the sacrificial anticorrosion material of the tube material (A) is 0.05 mass % or more and 0.30 mass % or less, preferably 0.10 mass % or more and 0.20 mass % or less. When the sacrificial anticorrosion material of the tube material (A) comprises Zr, the Zr content in the sacrificial anticorrosion material of the tube material (A) is 0.05 mass % or more and 0.30 mass % or less, preferably 0.10 mass % or more and 0.20 mass % or less. When the sacrificial anticorrosion material of the tube material (A) comprises Cr, the Cr content in the sacrificial anticorrosion material of the tube material (A) is 0.05 mass % or more and 0.30 mass % or less, preferably 0.10 mass % or more and 0.20 mass % or less. When the sacrificial anticorrosion material of the tube material (A) comprises V, the V content in the sacrificial anticorrosion material of the tube material (A) is 0.05 mass % or more and 0.30 mass % or less, preferably 0.10 mass % or more and 0.20 mass % or less. Ti, Zr, Cr and V in the sacrificial anticorrosion material of the tube material contribute the improvement of the corrosion resistance, particularly the resistance to pitting. Regions with a high content of Ti, Zr, Cr and V added to the aluminum alloy and regions with a low content thereof are separated and alternately distributed in a laminated form along the plate thickness direction of the material. The regions with a low content are preferentially corroded in comparison with the regions with a high content, so that a layered corrosion state is obtained. As a result, a difference in the rate of corrosion along the plate thickness direction of the material partially occurs, so that the progress of the corrosion is suppressed as a whole to improve the resistance to pitting. With a Ti, Zr, Cr or V content in the sacrificial anticorrosion material of the tube material below the range, the effect of the addition of Ti, Zr, Cr or V cannot be obtained, while with a content exceeding the range, a coarse compound may be formed in casting so as to inhibit the manufacturability in some cases.

The tube material (A) may comprise a brazing material comprising 3.00 mass % or more and 13.00 mass % or less of Si and 0.00 mass % or more and 0.05 mass % or less of Zn, with the balance being Al and unavoidable impurities, clad on a surface opposite to the surface clad with the sacrificial anticorrosion material. In other words, the tube material (A) may have a brazing material clad on the surface opposite to the surface clad with the sacrificial anode material of the core material. When the tube material (A) comprises a brazing material, the Si content in the tube material (A) is 3.00 mass % or more and 13.00 mass % cr less. With a Si content in the brazing material of the tube material (A), the function as the brazing material works. In contrast, with a Si content in the brazing material of the tube material (A) below the range, the effect of the addition of Si cannot be obtained, while v/ith a Si content exceeding the range, a giant intermetallic compound may crystallize to inhibit the manufacturability of the tube. Also, when the tube material (A) comprises a brazing material, a Zn content in the brazing material of the tube material (A) of 0.05 mass % or less is allowable.

The fin material (A) of the aluminum alloy heat exchanger for an exhaust gas recirculation system in a first embodiment according to the present invention is a fin material made of a core material only. In other words, the fin material (A) is a bare material. Also, the fin material (B) of the aluminum alloy heat exchanger for an exhaust gas recirculation system in a second embodiment according to the present invention is a three-layer clad material including a first brazing material clad on one surface of a core material and a second brazing material clad on another surface of the core material. The aluminum alloy heat exchanger for the exhaust gas recirculation system in the first embodiment according to the present invention is obtained by brazing the fin material (A) to a sacrificial anticorrosion material surface of the tube material (A). Also, the aluminum alloy heat exchanger for the exhaust gas recirculation system in the second embodiment according to the present invention is obtained by brazing the fin material (B) to a sacrificial anticorrosion material surface of the tube material (A).

The core material of the fin material (A) is made of aluminum alloy comprising 0.05 mass % or more and 1.50 mass % or less of Si, 0.40 mass % or more and 2.00 mass % or less of Mn, and 0 mass % or more and 0.05 mass % or less of Zn, with the balance being Al and unavoidable impurities.

The Si content in the core material of the fin material (A) is 0.05 mass % or more and 1.50 mass % or less, preferably 0.40 mass % or more and 0.80 mass % or less. With a Si content in the core material of the fin material (A) in the range, Si is solid-dissolved in a matrix or forms an Al-Mn-Si-based intermetallic compound, so that the strength of the fin after brazing is enhanced. In contrast, with a Si content below the range, the effect of the addition of Si cannot be obtained, while with a Si content exceeding the range, the corrosion resistance may decrease due to singly crystallized Si, and the excessively lowered melting point of the alloy results in melting of the fin material during brazing.

The Mn content in the core material of the fin material (A) is 0.40 mass % or more and 2.00 mass % or less, preferably 0.80 mass % or more and 1.60 mass % or less. With a Mn content of the core material of the fin material (A) in the range, Mn crystallizes or precipitates as an Al-Mn-based intermetallic compound to enhance the strength of the fin after brazing heating. Further, the Al-Mn-based intermetallic compound incorporates Fe, so that the inhibitory effect on anticorrosion by Fe as unavoidable impurity can be suppressed. In contrast, with a Mn content in the core material of the fin material below the range, the effect of the addition of Mn cannot be obtained, while with a Mn content exceeding the range, a giant intermetallic compound may crystallize to inhibit the manufacturability of the fin.

The Zn content in the core material of the fin material (A) is 0 mass or more and 0.05 mass % or less. In other words, the core material of the fin material (A) comprises no Zn, or 0.05 mass % or less even in the case of comprising Zn. With a Zn content of the core material of the fin material (A) in the range, the tube is forced to exhibit the sacrificial anticorrosion effect. Since aluminum comprising Zn lowers the pitting potential to function as sacrificial anticorrosion material, the sacrificial anticorrosion effect of the fin is usually expected by the addition of Zn to the fin. In contrast, in the present invention, with no addition of Zn to the fin, the tube is forced to exhibit the sacrificial anticorrosion effect.

The core material of the fin material (A) may further comprise one or more selected from the group consisting of 0.05 mass % or more and 0.50 mass % or less of Mg and 0.10 mass % or more and 1.00 mass % or less of Fe, on an as needed basis.

When the core material of the fin material (A) comprises Mg, the Mg content in the core material of the fin material (A) is 0.05 mass % or more and 0.50 mass % or less, preferably 0.10 mass % or more and 0.30 mass % or less. With a Mg content in the core material of the fin material (A) in the range, the corrosion resistance, particularly the resistance to pitting is enhanced. In contrast, with a Mg content in the core material of the fin material below the range, the effect of the addition of Mg cannot be obtained, while with a Mg content exceeding the range, brazing may be inhibited in some cases.

When the core material of the fin material (A) comprises Fe, the Fe content in the core material of the fin material (A) is 0.10 mass % or more and 1.00 mass % or less. With a Fe content in the core material of the fin material (A) in the range, the corrosion is dispersed to improve the penetration life. In contrast, with a Fe content in the core material of the fin material below the range, the effect of the addition of Fe cannot be obtained, while with a Fe content exceeding the range, the corrosion rate of the fin remarkably increases.

The core material of the fin material (B) is made of aluminum alloy comprising 0.05 mass % or more and 1.50 mass % or less of Si, 0.40 mass % or more and 2.00 mass % of or less Mn, and 0 mass % or more and 0.05 mass % or less of Zn, with the balance being Al and unavoidable impurities.

The Si content in the core material of the fin material (B) is 0.05 mass % or more and 1.50 mass % or less, preferably 0.40 mass % or more and 0.80 mass % or less. With a Si content in the core material of the fin material (B) in the range, Si is solid-dissolved in a matrix or forms an Al-Mn-Si-based intermetallic compound, so that the strength of the fin after brazing is enhanced. In contrast, with a Si content below the range, the effect of the addition of Si cannot be obtained, while with a Si content exceeding the range, the corrosion resistance may decrease due to singly crystallized Si, and the excessively lowered melting point of the alloy results in melting of the fin material during brazing.

The Mn content in the core material of the fin material (B) is 0.40 mass % or more and 2.00 mass % or less, preferably 0.80 mass % or more and 1.60 mass % or less. With a Mn content in the core material of the fin material (B) in the range, Mn crystallizes or precipitates as an Al-Mn-based intermetallic compound to enhance the strength of the fin after brazing heating. Further, the Al-Mn-based intermetallic compound incorporates Fe, so that the inhibitory effect on anticorrosion by Fe as unavoidable impurity can be suppressed. In contrast, with a Mn content in the core material of the fin material below the range, the effect of the addition of Mn cannot be obtained, while with a Mn content exceeding the range, a giant intermetallic compound may crystallize to inhibit the manufacturability of the fin.

The Zn content in the core material of the fin material (B) is 0.00 mass % or more and 0.05 mass % or less. In other words, the core material of the fin material (B) comprises no Zn, or 0.05 mass % or less even in the case of comprising Zn. With a Zn content of the core material of the fin material (B) in the range, the tube is forced to exhibit the sacrificial anticorrosion effect. Since aluminum comprising Zn lowers the pitting potential to function as sacrificial anticorrosion material, the sacrificial anticorrosion effect of the fin is usually expected by the addition of Zn to the fin. In contrast, in the present invention, with no addition of Zn to the fin, the tube is forced to exhibit the sacrificial anticorrosion effect.

The core material of the fin material (B) may further comprise one or more selected from the group consisting of 0.05 mass % or more and 0.50 mass % or less of Mg and 0.10 mass % or more and 1.00 mass % or less of Fe, on an as needed basis.

When the core material of the fin material (B) comprises Mg, the Mg content in the core material of the fin material (B) is 0.05 mass % or more and 0.50 mass % or less, preferably 0.10 mass % or more and 0.30 mass % or less. With a Mg content in the core material of the fin material (B) in the range, the corrosion resistance, particularly the resistance to pitting is enhanced. In contrast, with a Mg content below the range, the effect of the addition of Mg cannot be obtained, while with a Mg content exceeding the range, brazing may be inhibited in some cases.

When the core material of the fin material (B) comprises Fe, the Fe content in the core material of the fin material (B) is 0.10 mass % or more and 1.00 mass % or less. With a Fe content in the core material of the fin material (B) in the range, the corrosion is dispersed to improve the penetration life. In contrast, with a Fe content in the core material of the fin material below the range, the effect of the addition of Fe cannot be obtained, while with a Fe content exceeding the range, the corrosion rate of the fin remarkably increases.

Each of the first brazing material and the second brazing material of the fin material (B) is made of aluminum alloy comprising 3.00 mass % or more and 13.00 mass % or less of Si and 0.00 mass % or more and 0.05 mass % or less of Zn, with the balance being Al and unavoidable impurities. With a Si content in the first brazing material and the second brazing material of the fin material (B) in the range, the function as the brazing material works. In contrast, with a Si content in the brazing material of the fin material below the range, the effect of the addition of Si cannot be obtained, while with a Si content exceeding the range, a giant intermetallic compound may crystallize to inhibit the manufacturability of the fin.

The Zn content in each of the first brazing material and the second brazing material of the fin material (B) is 0.00 mass % or more and 0.05 mass % or less. In other words, the first brazing material and the second brazing material of the fin material (B) comprise no Zn, or 0.05 mass % or less even in the case of comprising Zn. With a Zn content in the first brazing material and the second brazing material of the fin material (B) in the range, the tube is forced to exhibit, the sacrificial anticorrosion effect. Since aluminum comprising Zn lowers the pitting potential to function as sacrificial anticorrosion material, the sacrificial anticorrosion effect of the fin is usually expected by the addition of Zn to the fin. In contrast, in the present invention, with no addition of Zn to the fin, the tube is forced to exhibit the sacrificial anticorrosion effect.

When the tube material or the fin material of an aluminum alloy heat exchanger for an exhaust gas recirculation system according to the present invention is a clad material, as the method for manufacturing the clad material, any routine procedure is employed without particular limitation, and the following method is preferred.

In the case of a tube material, first, ingots of a sacrificial anticorrosion material and a core material having a predetermined alloy composition are prepared by semi-continuous casting. In the case of further cladding a brazing material, an ingot of the brazing material is also prepared. Both of the surfaces of the ingots are machine-finished, and the two layers of the sacrificial anticorrosion material and the core material or the three layers of the sacrificial anticorrosion material, the core material and the brazing material are overlapped. Subsequently, preheating is performed at 400 to 550° C. for 1 to 10 hours, and the plate thickness is reduced to about 5 mm by hot rolling. Further, cold rolling and final annealing at 300 to 450° C. for 1 to 10 hours are performed to obtain a clad material having a thickness of about 0.3 mm. The clad ratio of the sacrificial anticorrosion material of a tube material is preferably 3 to 25%, particularly preferably 5 to 20%. The clad ratio of the brazing material of the tube material is preferably 5 to 20%, particularly preferably 8 to 15%.

In the case of a clad fin material, first, ingots of a core material and a brazing material having a predetermined alloy composition are prepared by semi-continuous casting. Both of the surfaces of the ingots are machine-finished, and the three layers of brazing material/core material/brazing material are overlapped. Subsequently, preheating is performed at 400 to 550° C. for 1 to 10 hours, and the plate thickness is reduced to about 5 mm by hot rolling. Further, cold rolling and final annealing at 300 to 450° C. for 1 to 10 hours are performed to obtain a clad material having a thickness of about 0.3 mm. The clad ratio of the brazing material of a fin material is preferably 5 to 20%, particularly preferably 8 to 15%.

### (Brazing Heating Condition)

The aluminum alloy heat exchanger for an exhaust gas recirculation system according to the present invention is manufactured by combining various components including a tube material and a fin material and brazing them. At least part, of the aluminum alloy heat exchanger for an exhaust gas recirculation system according to the present invention comprises a component comprising the fin material disposed on the surface of the sacrificial anticorrosion material of the tube material, which are joined to each other.

The brazing heating method and the brazing heating conditions are not particularly limited, and a brazing method using a fluoride-based non-corrosive flux in an inert gas atmosphere is preferred as the brazing method. As the brazing heating conditions, the time required for the step of heating from 400° C. to a brazing temperature for the completion of brazing solidification in the brazing operation and the step of cooling is not particularly limited, being preferably 7 to 40 minutes. Further, the time for maintaining at 580° C. or more is preferably 3 to 20 minutes.

The present invention is specifically described with reference to examples as follows. The present invention, however, is not limited to the examples described below. It is to be understood that various changes, modifications and improvements may be made in addition to the following Examples and the specific descriptions above based on the knowledge of those skilled in the art without departing from the spirit of the present invention.

### EXAMPLES

### Examples and Comparative Examples

### <Preparation of Tube Material>

Each of aluminum alloy ingots for the core material, the sacrificial anticorrosion material and the brazing material of the tube material having a composition shown in Tables 1 to 3 was cast by semi-continuous casting, which was machine-finished and subjected to homogenization treatment at 520° C. for 6 hours.

Subsequently, based on the combination shown in Table 5, the ingot for the sacrificial anticorrosion material was overlapped on one surface of the ingot for the core material. When a brazing material is clad, an ingot for the brazing material is overlapped on the opposite surface. Thereby overlapped ingots were prepared. The thickness of the sacrificial anticorrosion material and thickness of the brazing material were adjusted such that each had a clad ratio of 10%.

Subsequently, the overlapped ingots were heat treated up to 520° C. before the step of hot rolling, and immediately hot rolled to make a two-layer or three-layer clad plate having a thickness of 3.5 mm. Subsequently, the clad plate obtained was cold rolled to a thickness of 0.30 mm, and then annealed at 500° C. for 2 hours. Through the steps described above, a two-layer or three-layer tube material having a whole thickness of 0.30 mm and a clad ratio of the sacrificial anticorrosion material layer of 10% was prepared.

### <Preparation of Fin Material>

Each of aluminum alloy ingots for the brazing material and the core material for a fin material shown in Table 3 and Table 4 was cast by semi-continuous casting, which was machine-finished and subjected to homogenization treatment at 520° C. for 6 hours.

Subsequently, as shown in Table 5 to Table 7, from an ingot for the core material as it is, or based on the combination shown in Table 5 to Table 7, an ingot for the brazing material was overlapped on both surfaces of the ingot for the core material to prepare an ingot. The thickness of the brazing material was adjusted such that each had a clad ratio of 10%.

Subsequently, when the fin material is a clad material, the overlapped ingots were heat treated up to 520° C. before the step of hot rolling, and immediately hot rolled to make a three-layer clad plate having a thickness of 3.5 mm. Further, cold rolling and final annealing at 390 to 450° C. for 4 hours were performed to prepare a three-layer fin material having a thickness of about 0.1 mm.

When the fin material is a bare material, the ingot for core material was heat treated up to 520° C. before the step of hot rolling, and immediately hot rolled to make a plate having a thickness of 3.5 mm. Further, cold rolling and final annealing at 390 to 450° C. for 4 hours were performed to prepare a one-layer fin material having a thickness of about 0.1 mm.

### (Measurement of Tensile Strength After Brazing Heating)

A single sample of the tube material and a single sample of the fin material thus prepared were subjected to brazing heating at 600° C. for 3 minutes in a nitrogen atmosphere. After brazing heating, the sample was cooled to room temperature for use in a tensile test in accordance with JIS Z2241 under conditions with a tensile speed of 10 mm/minute and a gauge length of 50 mm. The tensile strength was determined from the stress-strain curve obtained.

### <Preparation of Test Sampler for Evaluation>

The fin material obtained above was slit into a width of 16 mm, corrugated, and formed into a fin shape for a heat exchanger.

Subsequently, the tube material was cut into a width of 16 mm and a length of 70 mm to prepare a test piece of tube material, and a KF-AlF-based flux (KAlF₄ or the like) powder was applied to the surface of the sacrificial anticorrosion material of the test piece of tube material.

Subsequently, the corrugated fin material was sandwiched between two test pieces of the tube material, such that the surface of the sacrificial anticorrosion was on the fin side, and brazing heating was performed at 600° C. for 3 minutes in a nitrogen atmosphere. After brazing heating, the temperature was cooled to room temperature, and a test sample for evaluation was prepared.

### (Measurement of Pitting Potential)

A tube and a fin were cut out from the test sample for evaluation, and portions other than the measurement surface were masked with epoxy resin. These were used as test materials, and as a pretreatment, the surfaces of the test materials were cleaned by immersing in a 5% NaOH aqueous solution at 60° C. for 30 seconds and in a 30% HNO₃ aqueous solution for 60 seconds. Subsequently, acetic acid was added to a 5% NaCl aqueous solution to adjust to pH 3, which was subjected to deaeration with nitrogen for 30 minutes to prepare a measurement solution. The tube or the fin was immersed in the measurement solution at 25° C., and an anodic polarization curve was measured using a potentiostat. In the polarization curve, the potential at which the current suddenly increased was defined as the pitting potential. The results are shown in Table 5.

### (Corrosion Resistance)

A test sample for evaluation was subjected to a cycle corrosion test including spraying for 2 hours (spray amount: 1 to 2 ml/80 cm²/h) using, as a spray liquid, an aqueous solution at pH 2.3 containing 6 ppm of hydrochloric acid, 10 ppm of sulfuric acid, 10 ppm of nitric acid, 5000 ppm of acetic acid and 5000 ppm of formic acid, drying (relative humidity: 20 to 30%) for 2 hours, and humidifying (relative humidity: 95% or more) for 2 hours. The temperature in the test chamber was set at 50° C., and the test time was set to 3000 hours. After completion of the test, the corrosion products were removed with concentrated nitric acid. The depth of the corroded pores generated on the surface of the sacrificial anticorrosion material was then measured by the focal depth method to determine a maximum one as the corrosion depth. A sample having a maximum corrosion depth of 100 μm or less was considered to be good, and a sample having a maximum corrosion depth of 100 μm or more was considered to be poor. The results are shown in Table 5 to Table 7.

TABLE 1

| | Si | Cu | Mn | Fe | Mg | Ni | Ti | V | Cr | Zr | Al |
|---|---|---|---|---|---|---|---|---|---|---|---|
| A1 | 0.50 | 0.50 | 1.00 | 0.10 | 0.00 | 0.00 | 0.00 | 0.00 | 0.00 | 0.00 | bal. |
| A2 | 0.05 | 0.50 | 1.00 | 0.10 | 0.00 | 0.00 | 0.00 | 0.00 | 0.00 | 0.00 | bal. |
| A3 | 1.50 | 0.50 | 1.00 | 0.10 | 0.00 | 0.00 | 0.00 | 0.00 | 0.00 | 0.00 | bal. |
| A4 | 0.50 | 0.05 | 1.00 | 0.10 | 0.00 | 0.00 | 0.00 | 0.00 | 0.00 | 0.00 | bal. |
| A5 | 0.50 | 3.00 | 1.00 | 0.10 | 0.00 | 0.00 | 0.00 | 0.00 | 0.00 | 0.00 | bal. |
| A6 | 0.50 | 0.50 | 0.40 | 0.10 | 0.00 | 0.00 | 0.00 | 0.00 | 0.00 | 0.00 | bal. |
| A7 | 0.50 | 0.50 | 2.00 | 0.10 | 0.00 | 0.00 | 0.00 | 0.00 | 0.00 | 0.00 | bal. |
| A8 | 0.50 | 0.50 | 1.00 | 0.10 | 0.05 | 0.00 | 0.00 | 0.00 | 0.00 | 0.00 | bal. |
| A9 | 0.50 | 0.50 | 1.00 | 0.10 | 0.50 | 0.00 | 0.00 | 0.00 | 0.00 | 0.00 | bal. |
| A10 | 0.50 | 0.50 | 1.00 | 0.20 | 0.00 | 0.00 | 0.00 | 0.00 | 0.00 | 0.00 | bal. |
| A11 | 0.50 | 0.50 | 1.00 | 1.00 | 0.00 | 0.00 | 0.00 | 0.00 | 0.00 | 0.00 | bal. |
| A12 | 0.50 | 0.50 | 1.00 | 0.10 | 0.00 | 0.05 | 0.00 | 0.00 | 0.00 | 0.00 | bal. |
| A13 | 0.50 | 0.50 | 1.00 | 0.10 | 0.00 | 1.00 | 0.00 | 0.00 | 0.00 | 0.00 | bal. |
| A14 | 0.50 | 0.50 | 1.00 | 0.10 | 0.00 | 0.00 | 0.05 | 0.00 | 0.00 | 0.00 | bal. |
| A15 | 0.50 | 0.50 | 1.00 | 0.10 | 0.00 | 0.00 | 0.30 | 0.00 | 0.00 | 0.00 | bal. |
| A16 | 0.50 | 0.50 | 1.00 | 0.10 | 0.00 | 0.00 | 0.00 | 0.05 | 0.00 | 0.00 | bal. |
| A17 | 0.50 | 0.50 | 1.00 | 0.10 | 0.00 | 0.00 | 0.00 | 0.30 | 0.00 | 0.00 | bal. |
| A18 | 0.50 | 0.50 | 1.00 | 0.10 | 0.00 | 0.00 | 0.00 | 0.00 | 0.05 | 0.00 | bal. |
| A19 | 0.50 | 0.50 | 1.00 | 0.10 | 0.00 | 0.00 | 0.00 | 0.00 | 0.30 | 0.00 | bal. |
| A20 | 0.50 | 0.50 | 1.00 | 0.10 | 0.00 | 0.00 | 0.00 | 0.00 | 0.00 | 0.05 | bal. |
| A21 | 0.50 | 0.50 | 1.00 | 0.10 | 0.00 | 0.00 | 0.00 | 0.00 | 0.00 | 0.30 | bal. |
| A22 | 0.01 | 0.50 | 1.00 | 0.10 | 0.00 | 0.00 | 0.00 | 0.00 | 0.00 | 0.00 | bal. |
| A23 | 2.00 | 0.50 | 1.00 | 0.10 | 0.00 | 0.00 | 0.00 | 0.00 | 0.00 | 0.00 | bal. |
| A24 | 0.50 | 0.01 | 1.00 | 0.10 | 0.00 | 0.00 | 0.00 | 0.00 | 0.00 | 0.00 | bal. |
| A25 | 0.50 | 5.00 | 1.00 | 0.10 | 0.00 | 0.00 | 0.00 | 0.00 | 0.00 | 0.00 | bal. |
| A26 | 0.50 | 0.50 | 0.30 | 0.10 | 0.00 | 0.00 | 0.00 | 0.00 | 0.00 | 0.00 | bal. |
| A27 | 0.50 | 0.50 | 2.50 | 0.10 | 0.00 | 0.00 | 0.00 | 0.00 | 0.00 | 0.00 | bal. |

TABLE 2

| | Si | Zn | Fe | Mn | Mg | Ni | In | Sn | Ti | V | Cr | Zr | Al |
|---|---|---|---|---|---|---|---|---|---|---|---|---|---|
| B1 | 7.00 | 2.00 | 0.10 | 0.00 | 0.00 | 0.00 | 0.00 | 0.00 | 0.00 | 0.00 | 0.00 | 0.00 | bal. |
| B2 | 3.00 | 2.00 | 0.10 | 0.10 | 0.00 | 0.00 | 0.00 | 0.00 | 0.00 | 0.00 | 0.00 | 0.00 | bal. |
| B3 | 13.00 | 2.00 | 0.10 | 0.00 | 0.00 | 0.00 | 0.00 | 0.00 | 0.00 | 0.00 | 0.00 | 0.00 | bal. |
| B4 | 7.00 | 0.50 | 0.10 | 0.00 | 0.00 | 0.00 | 0.00 | 0.00 | 0.00 | 0.00 | 0.00 | 0.00 | bal. |
| B5 | 7.00 | 6.00 | 0.10 | 0.00 | 0.00 | 0.00 | 0.00 | 0.00 | 0.00 | 0.00 | 0.00 | 0.00 | bal. |
| B6 | 7.00 | 2.00 | 0.10 | 0.05 | 0.00 | 0.00 | 0.00 | 0.00 | 0.00 | 0.00 | 0.00 | 0.00 | bal. |
| B7 | 7.00 | 2.00 | 0.10 | 2.00 | 0.00 | 0.00 | 0.00 | 0.00 | 0.00 | 0.00 | 0.00 | 0.00 | bal. |
| B8 | 7.00 | 2.00 | 0.10 | 0.00 | 0.05 | 0.00 | 0.00 | 0.00 | 0.00 | 0.00 | 0.00 | 0.00 | bal. |
| B9 | 7.00 | 2.00 | 0.10 | 0.00 | 0.50 | 0.00 | 0.00 | 0.00 | 0.00 | 0.00 | 0.00 | 0.00 | bal. |
| B10 | 7.00 | 2.00 | 0.20 | 0.00 | 0.00 | 0.00 | 0.00 | 0.00 | 0.00 | 0.00 | 0.00 | 0.00 | bal. |
| B11 | 7.00 | 2.00 | 1.00 | 0.00 | 0.00 | 0.00 | 0.00 | 0.00 | 0.00 | 0.00 | 0.00 | 0.00 | bal. |
| B12 | 7.00 | 2.00 | 0.10 | 0.00 | 0.00 | 0.05 | 0.00 | 0.00 | 0.00 | 0.00 | 0.00 | 0.00 | bal. |
| B13 | 7.00 | 2.00 | 0.10 | 0.00 | 0.00 | 1.00 | 0.00 | 0.00 | 0.00 | 0.00 | 0.00 | 0.00 | bal. |
| B14 | 7.00 | 2.00 | 0.10 | 0.00 | 0.00 | 0.00 | 0.05 | 0.00 | 0.00 | 0.00 | 0.00 | 0.00 | bal. |
| B15 | 7.00 | 2.00 | 0.10 | 0.00 | 0.00 | 0.00 | 0.30 | 0.00 | 0.00 | 0.00 | 0.00 | 0.00 | bal. |
| B16 | 7.00 | 2.00 | 0.10 | 0.00 | 0.00 | 0.00 | 0.00 | 0.05 | 0.00 | 0.00 | 0.00 | 0.00 | bal. |
| B17 | 7.00 | 2.00 | 0.10 | 0.00 | 0.00 | 0.00 | 0.00 | 0.30 | 0.00 | 0.00 | 0.00 | 0.00 | bal. |
| B18 | 7.00 | 2.00 | 0.10 | 0.00 | 0.00 | 0.00 | 0.00 | 0.00 | 0.05 | 0.00 | 0.00 | 0.00 | bal. |
| B19 | 7.00 | 2.00 | 0.10 | 0.00 | 0.00 | 0.00 | 0.00 | 0.00 | 0.30 | 0.00 | 0.00 | 0.00 | bal. |
| B20 | 7.00 | 2.00 | 0.10 | 0.00 | 0.00 | 0.00 | 0.00 | 0.00 | 0.00 | 0.05 | 0.00 | 0.00 | bal. |
| B21 | 7.00 | 2.00 | 0.10 | 0.00 | 0.00 | 0.00 | 0.00 | 0.00 | 0.00 | 0.30 | 0.00 | 0.00 | bal. |
| B22 | 7.00 | 2.00 | 0.10 | 0.00 | 0.00 | 0.00 | 0.00 | 0.00 | 0.00 | 0.00 | 0.05 | 0.00 | bal. |
| B23 | 7.00 | 2.00 | 0.10 | 0.00 | 0.00 | 0.00 | 0.00 | 0.00 | 0.00 | 0.00 | 0.30 | 0.00 | bal. |
| B24 | 7.00 | 2.00 | 0.10 | 0.00 | 0.00 | 0.00 | 0.00 | 0.00 | 0.00 | 0.00 | 0.00 | 0.05 | bal. |
| B25 | 7.00 | 2.00 | 0.10 | 0.00 | 0.00 | 0.00 | 0.00 | 0.00 | 0.00 | 0.00 | 0.00 | 0.30 | bal. |
| B26 | 2.00 | 2.00 | 0.10 | 0.00 | 0.00 | 0.00 | 0.00 | 0.00 | 0.00 | 0.00 | 0.00 | 0.00 | bal. |
| B27 | 15.00 | 2.00 | 0.10 | 0.00 | 0.00 | 0.00 | 0.00 | 0.00 | 0.00 | 0.00 | 0.00 | 0.00 | bal. |
| B28 | 7.00 | 0.10 | 0.10 | 0.00 | 0.00 | 0.00 | 0.00 | 0.00 | 0.00 | 0.00 | 0.00 | 0.00 | bal. |
| B29 | 7.00 | 8.00 | 0.10 | 0.00 | 0.00 | 0.00 | 0.00 | 0.00 | 0.00 | 0.00 | 0.00 | 0.00 | bal. |

TABLE 3

| | Si | Zn | Al |
|---|---|---|---|
| D1 | 7.00 | 0.00 | bal. |
| D2 | 3.00 | 0.00 | bal. |
| D3 | 13.00 | 0.00 | bal. |
| D4 | 7.00 | 0.05 | bal. |
| D5 | 7.00 | 2.00 | bal. |

TABLE 4

| | Si | Mn | Zn | Fe | Mg | Al |
|---|---|---|---|---|---|---|
| C1 | 0.50 | 1.00 | 0.00 | 0.10 | 0.00 | bal. |
| C2 | 0.05 | 1.00 | 0.00 | 0.10 | 0.00 | bal. |
| C3 | 1.50 | 1.00 | 0,00 | 0.10 | 0.00 | bal. |
| C4 | 0.50 | 0.40 | 0.00 | 0.10 | 0.00 | bal. |
| C5 | 0.50 | 2.00 | 0.00 | 0.10 | 0.00 | bal. |
| C6 | 0.50 | 1.00 | 0.05 | 0.10 | 0.00 | bal. |
| C7 | 0.50 | 1.00 | 0.00 | 0.10 | 0.05 | bal. |
| C8 | 0.50 | 1.00 | 0.00 | 0.10 | 0.50 | bal. |
| C9 | 0.50 | 1.00 | 0.00 | 0.20 | 0.00 | bal. |
| C10 | 0.50 | 1.00 | 0.00 | 1.00 | 0.00 | bal. |
| C11 | 0.01 | 1.00 | 0.00 | 0.10 | 0.00 | bal. |
| C12 | 2.00 | 1.00 | 0.00 | 0.10 | 0.00 | bal. |
| C13 | 0.50 | 0.20 | 0.00 | 0.10 | 0.00 | bal. |
| C14 | 0.50 | 2.50 | 0.00 | 0.10 | 0.00 | bal. |
| C15 | 0.50 | 1.00 | 0.20 | 0.10 | 0.00 | bal. |
| C16 | 0.50 | 1.00 | 2.00 | 0.10 | 0.00 | bal |

TABLE 5

| | | | | | | (Potential | |
|---|---|---|---|---|---|---|---|
| | | | | | | of fin)- | |
| | | | | | | (Pitting | |
| | | | | | | potential | Corrosion |
| | Tube/ | Tube/ | | Fin/ | Fin/ | of tube | test |
| | Core | Sacrificial | Tube/ | Core | Brazing | surface)/ | result/ |
| | material | material | Brazing | material | material | mV | μm |
| Example 1 | A1 | B1 | — | C1 | — | 82 | 64 |
| Example 2 | A2 | B1 | — | C1 | — | 84 | 52 |
| Example 3 | A3 | B1 | — | C1 | — | 90 | 64 |
| Example 4 | A4 | B1 | — | C1 | — | 86 | 54 |
| Example 5 | A5 | B1 | — | C1 | — | 86 | 64 |
| Example 6 | A6 | B1 | — | C1 | — | 76 | 54 |
| Example 7 | A7 | B1 | — | C1 | — | 84 | 64 |
| Example 8 | A8 | B1 | — | C1 | — | 84 | 42 |
| Example 9 | A9 | B1 | — | C1 | — | 90 | 36 |
| Example 10 | A10 | B1 | — | C1 | — | 86 | 40 |
| Example 11 | A11 | B1 | — | C1 | — | 90 | 30 |
| Example 12 | A12 | B1 | — | C1 | — | 92 | 48 |
| Example 13 | A13 | B1 | — | C1 | — | 76 | 40 |
| Example 14 | A14 | B1 | — | C1 | — | 78 | 40 |
| Example 15 | A15 | B1 | — | C1 | — | 78 | 48 |
| Example 16 | A16 | B1 | — | C1 | — | 76 | 48 |
| Example 17 | A17 | B1 | — | C1 | — | 84 | 48 |
| Example 18 | A18 | B1 | — | C1 | — | 78 | 40 |
| Example 19 | A19 | B1 | — | C1 | — | 88 | 30 |
| Example 20 | A20 | B1 | — | C1 | — | 84 | 38 |
| Example 21 | A21 | B1 | — | C1 | — | 92 | 32 |
| Example 22 | A1 | B1 | — | C1 | D1 | 81 | 58 |
| Example 23 | A1 | B1 | — | C1 | D2 | 78 | 61 |
| Example 24 | A1 | B1 | — | C1 | D3 | 80 | 52 |
| Example 25 | A1 | B1 | — | C1 | D4 | 80 | 59 |
| Example 26 | A18 | B1 | D1 | C1 | — | 78 | 40 |
| Example 27 | A19 | B1 | D2 | C1 | — | 88 | 30 |
| Example 28 | A20 | B1 | D3 | C1 | — | 84 | 38 |
| Example 29 | A21 | B1 | D4 | C1 | — | 92 | 32 |

TABLE 6

| | | | | | | (Potential | |
|---|---|---|---|---|---|---|---|
| | | | | | | of fin)- | |
| | | | | | | (Pitting | |
| | | | | | | potential | Corrosion |
| | Tube/ | Tube/ | | Fin/ | Fin/ | of tube | test |
| | Core | Sacrificial | Tube/ | Core | Brazing | surface)/ | result/ |
| | material | material | Brazing | material | material | mV | μm |
| Example 30 | A1 | B2 | — | C1 | — | 73 | 68 |
| Example 31 | A1 | B3 | — | C1 | — | 89 | 64 |
| Example 32 | A1 | B4 | — | C1 | — | 46 | 86 |
| Example 33 | A1 | B5 | — | C1 | — | 185 | 68 |
| Example 34 | A1 | B6 | — | C1 | — | 73 | 30 |
| Example 35 | A1 | B7 | — | C1 | — | 73 | 48 |
| Example 36 | A1 | B8 | — | C1 | — | 92 | 40 |
| Example 37 | A1 | B9 | — | C1 | — | 86 | 32 |
| Example 38 | A1 | B10 | — | C1 | — | 92 | 34 |
| Example 39 | A1 | B11 | — | C1 | — | 76 | 48 |
| Example 40 | A1 | B12 | — | C1 | — | 80 | 50 |
| Example 41 | A1 | B13 | — | C1 | — | 86 | 48 |
| Example 42 | A1 | B14 | — | C1 | — | 109 | 40 |
| Example 43 | A1 | B15 | — | C1 | — | 163 | 44 |
| Example 44 | A1 | B16 | — | C1 | — | 101 | 36 |
| Example 45 | A1 | B17 | — | C1 | — | 165 | 36 |
| Example 46 | A1 | B18 | — | C1 | — | 84 | 46 |
| Example 47 | A1 | B19 | — | C1 | — | 76 | 38 |
| Example 48 | A1 | B20 | — | C1 | — | 76 | 48 |
| Example 49 | A1 | B21 | — | C1 | — | 86 | 30 |
| Example 50 | A1 | B22 | — | C1 | — | 80 | 34 |
| Example 51 | A1 | B23 | — | C1 | — | 90 | 44 |
| Example 52 | A1 | B24 | — | C1 | — | 78 | 34 |
| Example 53 | A1 | B25 | — | C1 | — | 92 | 38 |
| Example 54 | A1 | B1 | D1 | C1 | — | 82 | 64 |
| Example 55 | A1 | B1 | D2 | C1 | — | 82 | 64 |
| Example 56 | A1 | B1 | D3 | C1 | — | 82 | 64 |
| Example 57 | A1 | B1 | D4 | C1 | — | 82 | 64 |
| Example 58 | A1 | B1 | — | C2 | — | 99 | 68 |
| Example 59 | A1 | B1 | — | C3 | — | 71 | 52 |
| Example 60 | A1 | B1 | — | C4 | — | 77 | 52 |
| Exampe 61 | A1 | B1 | — | C5 | — | 96 | 64 |
| Example 62 | A1 | B1 | — | C6 | — | 76 | 70 |
| Example 63 | A1 | B1 | — | C7 | — | 77 | 44 |
| Example 64 | A1 | B1 | — | C8 | — | 88 | 42 |
| Example 65 | A1 | B1 | — | C11 | — | 80 | 42 |
| Example 66 | A1 | B1 | — | C12 | — | 92 | 34 |

TABLE 7

| | | | | | | (Potential | |
|---|---|---|---|---|---|---|---|
| | | | | | | of fin)- | |
| | | | | | | (Pitting | |
| | | | | | | potential | Corrosion |
| | Tube/ | Tube/ | | Fin/ | Fin/ | of tube | test |
| | Core | Sacrificial | Tube/ | Core | Brazing | surface)/ | result/ |
| | material | material | Brazing | material | material | mV | μm |
| Comparative | A22 | B1 | — | C1 | — | 86 | 86 |
| Example 1 | | | | | | | |
| Comparative | A24 | B1 | — | C1 | — | 90 | 124 |
| Example 2 | | | | | | | |
| Comparative | A26 | B1 | — | C1 | — | 88 | 88 |
| Example 3 | | | | | | | |
| Comparative | A1 | B26 | — | C1 | — | 55 | 55 |
| Example 4 | | | | | | | |
| Comparative | A1 | B28 | — | C1 | — | 5 | 150 |
| Example 5 | | | | | | | |
| Comparative | A1 | B1 | — | C11 | — | 89 | 78 |
| Example 6 | | | | | | | |
| Comparative | A1 | B1 | — | C13 | — | 62 | 90 |
| Example 7 | | | | | | | |
| Comparative | A1 | B1 | — | C15 | — | −7 | 201 |
| Example 8 | | | | | | | |
| Comparative | A23 | B1 | — | C1 | — | — | — |
| Example 9 | | | | | | | |
| Comparative | A25 | B1 | — | C1 | — | — | — |
| Example 10 | | | | | | | |
| Comparative | A27 | B1 | — | C1 | — | — | — |
| Example 11 | | | | | | | |
| Comparative | A1 | B27 | — | C1 | — | — | — |
| Example 12 | | | | | | | |
| Comparative | A1 | B29 | — | C1 | — | — | — |
| Example 13 | | | | | | | |
| Comparative | A1 | B1 | — | C12 | — | — | — |
| Example 14 | | | | | | | |
| Comparative | A1 | B1 | — | C14 | — | — | — |
| Example 15 | | | | | | | |
| Comparative | A1 | B1 | — | C16 | — | −54 | 251 |
| Example 16 | | | | | | | |
| Comparative | A1 | B1 | — | C1 | D5 | −50 | 271 |
| Example 17 | | | | | | | |

In all Examples, there existed no problem with manufacturability of the tube material or the fin material, the brazing property was good with a tube strength after brazing of 140 MPa or more and a fin strength after brazing of 120 MPa or more, and the corrosion resistance after the cycle corrosion test was excellent.

In Comparative Example 1, the tube core material had a low Si content, so that the tube after brazing had a low strength of 136 MPa.

In Comparative Example 2, the tube core material had a low Cu content, so that the tube after brazing had a low strength of 129 MPa.

In Comparative Example 3, the tube core material had a low Mn content, so that the tube after brazing had a low strength of 134 MPa.

In Comparative Example 4, the sacrificial anode material had a low Si content, so that defective brazing of the fin occurred.

In Comparative Example 5, the sacrificial anode material had a low Zn content, so that the corrosion resistance of the tube was poor.

In Comparative Example 6, the fin material had a low Si content, so that the fin after brazing had a low strength of 102 MPa.

In Comparative Example 7, the fin material had a low Mn content, so that the fin after brazing had a low strength of 74 MPa. In Comparative Example 8, the fin material had a low Zn content, so that the corrosion resistance was poor.

In Comparative Examples 9 to 15, melting or cracking occurred during manufacturing of the tube material or the fin material, so that the subsequent evaluations were unable to be performed.

In Comparative Example 16, the core material of the fin had a high Zn content, so that the fin was corroded in an early stage, so that the corrosion resistance of the tube was poor.

In Comparative Example 17, the brazing material of the fin had a high Zn content, so that the fin was corroded in an early stage and the corrosion resistance of the tube was poor.

1. An aluminum alloy heat exchanger for an exhaust gas recirculation system, which is a heat exchanger installed in an exhaust gas recirculation system of an internal combustion engine to cool the exhaust gas, the heat exchanger comprising:
a tube provided with a sacrificial anticorrosion material on a side along which the exhaust gas passes, and a fin brazed to a sacrificial anticorrosion material surface side of the tube, the fin having a pitting potential higher than a pitting potential of a sacrificial anticorrosion material surface of the tube.

2. The aluminum alloy heat exchanger for an exhaust gas recirculation system according to claim 1, wherein the condensed water of the exhaust gas has a pH of less than 3 and a chloride ion concentration of less than 100 ppm.

3. The aluminum alloy heat exchanger for an exhaust gas recirculation system according to claim 1, wherein the heat exchanger is obtained by brazing:
a tube material comprising at least a core material made of aluminum alloy comprising 0.05 mass % or more and 1.50 mass % or less of Si, 0.05 mass % or more and 3.00 mass % or less of Cu, and 0.40 mass % or more and 2.00 mass % or less of Mn, and optionally one or more selected from the group consisting of 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V, with the balance being Al and unavoidable impurities, and a sacrificial anticorrosion material made of aluminum alloy comprising 3.00 mass % or more and 13.00 mass % or less of Si and 0.50 mass % or more and 6.00 mass % or less of Zn, and optionally one or more selected from the group consisting of 0.05 mass % or more and 2.00 mass % or less of Mn, 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of In, 0.05 mass % or more and 0.30 mass % or less of Sn, 0.05 mass % or more and 0.30 mass % or less of Ti, 0.05 mass % or more and 0.30 mass % or less of V, 0.05 mass % or more and 0.30 mass % or less of Cr, and 0.05 mass % or more and 0.30 mass % or less of Zr, with the balance being Al and unavoidable impurities, clad on an exhaust gas passage side surface of the core material; and
a fin material comprising a core material made of aluminum alloy comprising 0.05 mass % or more and 1.50 mass % or less of Si, 0.40 mass % or more and 2.00 mass % or less of Mn, and 0.00 mass % or more and 0.05 mass % or less of Zn, and optionally one or more selected from the group consisting of 0.05 mass % or more and 0.50 mass % or less of Mg and 0.10 mass % or more and 1.00 mass % or less of Fe, with the balance being Al and unavoidable impurities.

4. (canceled)

5. The aluminum alloy heat exchanger for an exhaust gas recirculation system according to claim 1, wherein the heat exchanger is obtained by brazing:
a tube material comprising at least a core material made of aluminum alloy comprising 0.05 mass % or more and 1.50 mass % or less of Si, 0.05 mass % or more and 3.00 mass % or less of Cu, and 0.40 mass % or more and 2.00 mass % or less of Mn, and optionally one or more selected from the group consisting of 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V, with the balance being Al and unavoidable impurities, and a sacrificial anticorrosion material made of aluminum alloy comprising 3.00 mass % or more and 13.00 mass % or less of Si, and 0.50 mass % or more and 6.00 mass % or less of Zn, and optionally one or more selected from the group consisting of 0.05 mass % or more and 2.00 mass % or less of Mn, 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of In, 0.05 mass % or more and 0.30 mass % or less of Sn, 0.05 mass % or more and 0.30 mass % or less of Ti, 0.05 mass % or more and 0.30 mass % or less of V, 0.05 mass % or more and 0.30 mass % or less of Cr, and 0.05 mass % or more and 0.30 mass % or less of Zr, with the balance being Al and unavoidable impurities, clad on an exhaust gas passage side surface of the core material; and
a fin material comprising a core material made of aluminum alloy comprising 0.05 mass % or more and 1.50 mass % or less of Si, 0.40 mass % or more and 2.00 mass % or less of Mn, and 0.00 mass % or more and 0.05 mass % or less of Zn, with the balance being Al and unavoidable impurities, and a first brazing material clad on one surface of the core material and a second brazing material clad on another surface of the core material, made of aluminum alloy comprising 3.00 mass % or more and 13.00 mass % or less of Si and 0.00 mass % or more and 0.05 mass % or less of Zn, and optionally one or more selected from the group consisting of 0.05 mass % or more and 0.50 mass % or less of Mg and 0.10 mass % or more and 1.00 mass % or less of Fe, with the balance being Al and unavoidable impurities.

6. (canceled)

7. The aluminum alloy heat exchanger for an exhaust gas recirculation system according to claim 3, wherein the tube material comprises a brazing material comprising 3.00 mass % or more and 13.00 mass % or less of Si and 0.00 mass % or more and 0.05 mass % or less of Zn, with the balance being Al and unavoidable impurities, clad on a surface opposite to the surface clad with the sacrificial anticorrosion material of the tube material.

8-9. (canceled)

10. The aluminum alloy heat exchanger for an exhaust gas recirculation system according to claim 2, wherein the heat exchanger is obtained by brazing:
a tube material comprising at least a core material made of aluminum alloy comprising 0.05 mass % or more and 1.50 mass % or less of Si, 0.05 mass % or more and 3.00 mass % or less of Cu, and 0.40 mass % or more and 2.00 mass % or less of Mn, and optionally one or more selected from the group consisting of 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V, with the balance being Al and unavoidable impurities, and a sacrificial anticorrosion material made of aluminum alloy comprising 3.00 mass % or more and 13.00 mass % or less of Si and 0.50 mass % or more and 6.00 mass % or less of Zn, and optionally one or more selected from the group consisting of 0.05 mass % or more and 2.00 mass % or less of Mn, 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of In, 0.05 mass % or more and 0.30 mass % or less of Sn, 0.05 mass % or more and 0.30 mass % or less of Ti, 0.05 mass % or more and 0.30 mass % or less of V, 0.05 mass % or more and 0.30 mass % or less of Cr, and 0.05 mass % or more and 0.30 mass % or less of Zr, with the balance being Al and unavoidable impurities, clad on an exhaust gas passage side surface of the core material; and
a fin material comprising a core material made of aluminum alloy comprising 0.05 mass % or more and 1.50 mass % or less of Si, 0.40 mass % or more and 2.00 mass % or less of Mn, and 0.00 mass % or more and 0.05 mass % or less of Zn, and optionally one or more selected from the group consisting of 0.05 mass % or more and 0.50 mass % or less of Mg and 0.10 mass % or more and 1.00 mass % or less of Fe, with the balance being Al and unavoidable impurities.

11. The aluminum alloy heat exchanger for an exhaust gas recirculation system according to claim 2, wherein the heat exchanger is obtained by brazing:
a tube material comprising at least a core material made of aluminum alloy comprising 0.05 mass % or more and 1.50 mass % or less of Si, 0.05 mass % or more and 3.00 mass % or less of Cu, and 0.40 mass % or more and 2.00 mass % or less of Mn, and optionally one or more selected from the group consisting of 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of Cr, 0.05 mass % or more and 0.30 mass % or less of Zr, 0.05 mass % or more and 0.30 mass % or less of Ti, and 0.05 mass % or more and 0.30 mass % or less of V, with the balance being Al and unavoidable impurities, and a sacrificial anticorrosion material made of aluminum alloy comprising 3.00 mass % or more and 13.00 mass % or less of Si, and 0.50 mass % or more and 6.00 mass % or less of Zn, and optionally one or more selected from the group consisting of 0.05 mass % or more and 2.00 mass % or less of Mn, 0.05 mass % or more and 0.50 mass % or less of Mg, 0.10 mass % or more and 1.00 mass % or less of Fe, 0.05 mass % or more and 1.00 mass % or less of Ni, 0.05 mass % or more and 0.30 mass % or less of In, 0.05 mass % or more and 0.30 mass % or less of Sn, 0.05 mass % or more and 0.30 mass % or less of Ti, 0.05 mass % or more and 0.30 mass % or less of V, 0.05 mass % or more and 0.30 mass % or less of Cr, and 0.05 mass % or more and 0.30 mass % or less of Zr, with the balance being Al and unavoidable impurities, clad on an exhaust gas passage side surface of the core material; and
a fin material comprising a core material made of aluminum alloy comprising 0.05 mass % or more and 1.50 mass % or less of Si, 0.40 mass % or more and 2.00 mass % or less of Mn, and 0.00 mass % or more and 0.05 mass % or less of Zn, with the balance being Al and unavoidable impurities, and a first brazing material clad on one surface of the core material and a second brazing material clad on another surface of the core material, made of aluminum alloy comprising 3.00 mass % or more and 13.00 mass % or less of Si and 0.00 mass % or more and 0.05 mass % or less of Zn, and optionally one or more selected from the group consisting of 0.05 mass % or more and 0.50 mass % or less of Mg and 0.10 mass % or more and 1.00 mass % or less of Fe, with the balance being Al and unavoidable impurities.

12. The aluminum alloy heat exchanger for an exhaust gas recirculation system according to claim 5, wherein the tube material comprises a brazing material comprising 3.00 mass % or more and 13.00 mass % or less of Si and 0.00 mass % or more and 0.05 mass % or less of Zn, with the balance being Al and unavoidable impurities, clad on a surface opposite to the surface clad with the sacrificial anticorrosion material of the tube material.

13. The aluminum alloy heat exchanger for an exhaust gas recirculation system according to claim 7, wherein the tube material comprises a brazing material comprising 3.00 mass % or more and 13.00 mass % or less of Si and 0.00 mass % or more and 0.05 mass % or less of Zn, with the balance being Al and unavoidable impurities, clad on a surface opposite to the surface clad with the sacrificial anticorrosion material of the tube material.

14. The aluminum alloy heat exchanger for an exhaust gas recirculation system according to claim 11, wherein the tube material comprises a brazing material comprising 3.00 mass % or more and 13.00 mass % or less of Si and 0.00 mass % or more and 0.05 mass % or less of Zn, with the balance being Al and unavoidable impurities, clad on a surface opposite to the surface clad with the sacrificial anticorrosion material of the tube material.
